(19) United States
(12) Patent Application Publication
(10) Pub. No.: US 2018/0234660 A1
(43) Pub. Date: Aug. 16, 2018

(54) LIMITED AND TEMPORARY QUEUING OF VIDEO DATA CAPTURED BY A PORTABLE CAMERA PRIOR TO USER INITIATION OF VIDEO RECORDING COMMANDS

(71) Applicant: Nxtgen Technology, Inc., Barrington, IL (US)

(72) Inventors: Robert E. Fitzgerald, North Barrington, IL (US); Luis M. Ortiz, Albuquerque, NM (US)

(73) Assignee: Nxtgen Technology, Inc.

(21) Appl. No.: 15/892,831

(22) Filed: Feb. 9, 2018

Related U.S. Application Data
(60) Provisional application No. 62/457,326, filed on Feb. 10, 2017.

(51) Int. Cl. H04N 5/77; H04N 5/225; H04N 5/232

(52) U.S. Cl. CPC H04N 5/772; H04N 5/23216; H04N 5/2257

(57) ABSTRACT

Limited and temporary queuing of video data captured by a portable device prior to user initiation of video recording commands using a portable device that includes a digital camera, a memory for queuing pre-record command video and for storing video after a record command is initiated by a user, a user interface for a user to initiate the record command to cause the camera to capture and the portable device to store the video, and software that specially adapts the portable device to enable pre-record command video capture and queuing, post-command video capture, and storage of combined pre-record command video and post-record command video upon user activation of the record command on the user interface. The portable device can be, inter alia, a smartphone, eyeglasses, headgear, and lapel camera. A wearable device can maintain wireless communication with a portable computer providing network access and social media application functionality/integration.

### INVENTION PRIORITY

The present application is a continuation of U.S. Provisional Application Ser. No. 62/457,326, filed Feb. 10, 2017, entitled “Limited and Temporary Queuing of Video Data Captured by a Portable Camera Prior to User Initiation of Video Recording Commands,” which is incorporated herein in its entirety for its teaching.

### TECHNICAL FIELD

The present invention is related to video recording using portable devices such as smartphones, cameras and wearable devices that incorporate digital cameras. More particularly, the present invention is related to systems and methods enabling the limited and temporary queuing of video data captured by a portable camera prior to user initiation of video recording commands.

### BACKGROUND

Portable digital cameras are in wide use worldwide. Most every portable computer (e.g., smartphones, tablet computers) includes a digital camera and video recording capabilities. Video cameras and image capturing capabilities have also more been included in wearable devices, such as eyeglasses, goggles, and lapel cameras. Most recently, Snap Inc., which operates the widely used “Snapchat” services and provides the user with the “Snapchat” application download for portable computers, announced the “Spectacles” product, which involves user wearable glasses that include an integrated digital camera for capturing images at the command of a user while the glasses are worn on the user's face. The Spectacles can capture a ten second video only after its user presses a button on the frame of the glasses. A light on the glasses shows people nearby that the user is capturing images (which may include them). The glasses can be integrated with a user's portable computer (e.g., smartphone or tablet). The captured video data can be added wirelessly to the users social media account via the user's portable computer. The glasses can be charged while they are stored in their case. These are the primary features of the Snap Inc. device.

Video capturing is not only done for recreational purposes, but it can also be important for security purposes. Police officers are wearing lapel, or body, cameras during their work shifts. There are also numerous industrial, medical, and commercial applications for wearable cameras as well. Despite the phenomenal growth of portable digital camera use and the newest technology application like Snap Inc.'s Spectacle, there is still a need for users to capture a broader duration of live activity.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

The present inventors have expanded the capabilities of portable digital photography using portable devices by enabling a broader perspective than has been possible before the present invention. Whether a user is utilizing a portable computer, such as a smartphone or tablet, or a wearable camera, such as Spectacles, video of live activity prior to user activation of a record feature on their portable device is now possible given the present invention.

In accordance with an example embodiment, a portable device can be equipped with a digital camera for capturing video of a live event, a memory for queuing pre-record command video and for also storing video after a record command is initiated by a user, a user interface for a user to initiate the record command to cause the camera to capture and the portable device to store the video, and software that enables pre-record command video capture and queuing, post command video capture, and storage of combined pre-record command video and post record command video as a single file upon user activation of the record command on the user interface.

In another example embodiment, the portable device can be wearable and maintains wireless communication with a portable computer which provides data network access and social media application functionality for carrying out pre-record command video queuing, post record command video capturing, combined pre- and post-command video storing, and social network video integration and functionality.

In yet another example embodiment, the portable device can be at least one of: a smartphone, a tablet computer, eyeglasses, goggles, a hat, a helmet, a lapel camera, and a portable digital camera.

In still another example embodiment, the portable device is a smartphone that further includes an accelerometer to detect upright orientation of the smartphone that is typical when capturing video, and pre-record command video capturing begins during upright orientation and is stored in memory for a limited/temporary basis until user activation of a record command is received on the user interface, where after pre-record command video is combined with post-record command video and stored in memory.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a system architecture in accordance with an example embodiment;

FIG. 2 illustrates a flow chart of a method in accordance with an example embodiment;

FIG. 3 illustrates a portable device in accordance with the embodiments;

FIG. 4 illustrates a variety of configurations for a portable device in accordance with the embodiments;

FIG. 5 illustrates various portable devices in accordance with varying example embodiments;

FIG. 6 illustrates a portable device provided in the form of a firearm, in accordance with an example embodiment;

FIG. 7 illustrates a schematic view of a computer system, in accordance with an embodiment; and

FIG. 8 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms, such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation”.

The disclosed example embodiments expand capabilities of portable digital photography when using portable devices to capture video. The example embodiments enable a broader perspective than has been possible. Whether a user is utilizing a portable computer, such as a smartphone or tablet, or a wearable camera, video of live activity prior to user activation of a record feature on their portable device is now possible given the present embodiment.

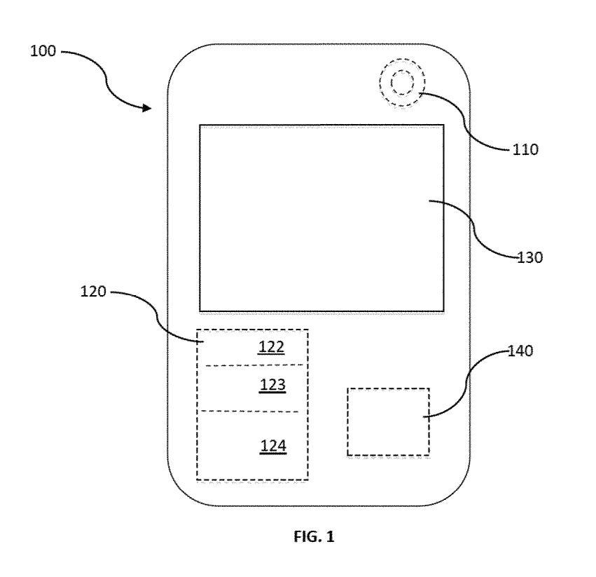

Referring to FIG. 1, a system architecture is illustrated in accordance with an example embodiment. A portable device 100 can be equipped with a digital camera 110 for capturing video of a live event, a memory 120 for queuing pre-record command video 122 and for also storing post-record command video 123 after a record command is initiated by a user, a user interface 130 for enabling a user to initiate the record command causing the camera 110 to capture video and the portable device 100 to store the video in the memory 120, and software 140 configuring the portable device to enable pre-record command video capture and queuing, post command video capture, combining of pre-record command video with post-record command video, and the storage of combined pre-record command video and post record command video as a single file 124 upon user activation of the record command on the user interface 130.

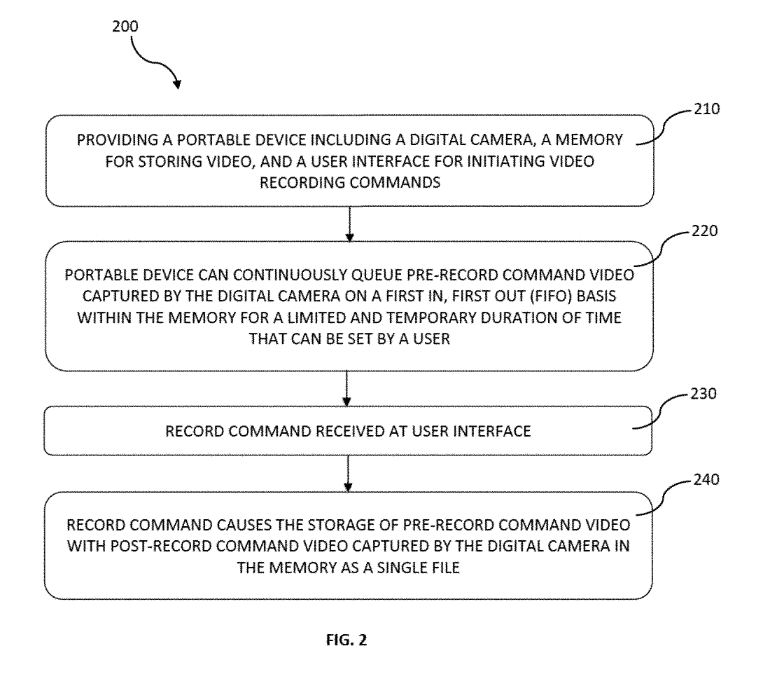

Referring to FIG. 2, a flow chart of operations depicting logical operational steps of a method 200 for capturing, combining, and recording pre- and post-record command video via a portable device is disclosed in accordance with an example embodiments. The flow chart shown in FIG. 2 depicts a method 200 for limited and temporary queuing of video data captured by a portable device prior to user initiation of video recording commands using the portable device. Such a method 200 can include a step of providing a portable device including a digital camera, a memory for storing video, and a user interface for initiating video recording commands, as shown at block 210. As depicted at block 220, the portable device can continuously queue pre-record command video captured by the digital camera on a first in, first out (FIFO) basis within the memory for a limited and temporary duration of time that can be set by the user. FIFO is a method for organizing and manipulating a data buffer, wherein the oldest (first) entry, or “head” of the queue is processed first. The duration of pre-record command video can be set up by a user in a profile of the portable device, which can be accessed via the user interface. Then as illustrated at block 230, a record command can be received at the user interface. The record command then causes the storage of pre-record command video with post-record command video captured by the digital camera in the memory as a single file, as shown at block 240.

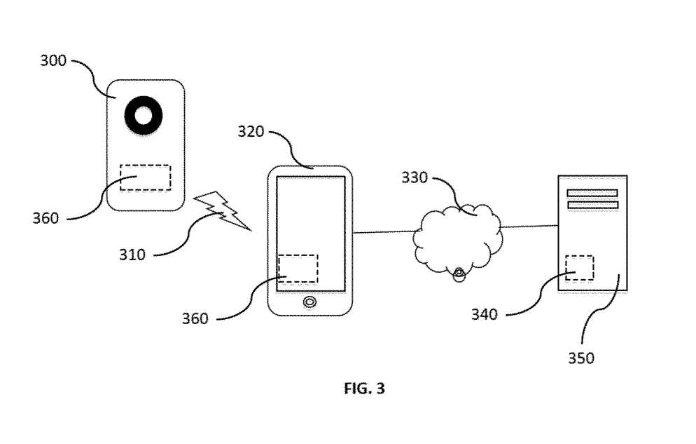

As indicated in FIG. 3, a portable device 300 in accordance with the embodiments can be wearable and can maintain short range wireless communication 310 (e.g., Bluetooth) with a portable computer 320, which can provide wireless data communications network access 330 (e.g., Wifi, 3g/4g/5G cellular) and access to social media application and service functionality 340 that can typically be hosted on a remote server 350. Software 360 can be provided in the portable device 300, portable computer 320, or both, for carrying out pre-record command video queuing, post-record command video capturing, combined pre- and post-record command video file storage, and social network access, video integration and functionality.

Referring to FIG. 4, a variety of configurations 400 for a portable device in accordance with the embodiments are illustrated. The portable device with video camera and recording capabilities in accordance with the embodiments can be provided as at least one of: a smartphone or a tablet computer 410, a lapel camera 420, a portable digital camera 430, a hat 440, a helmet 450/460, goggles 470, and eyeglasses 480.

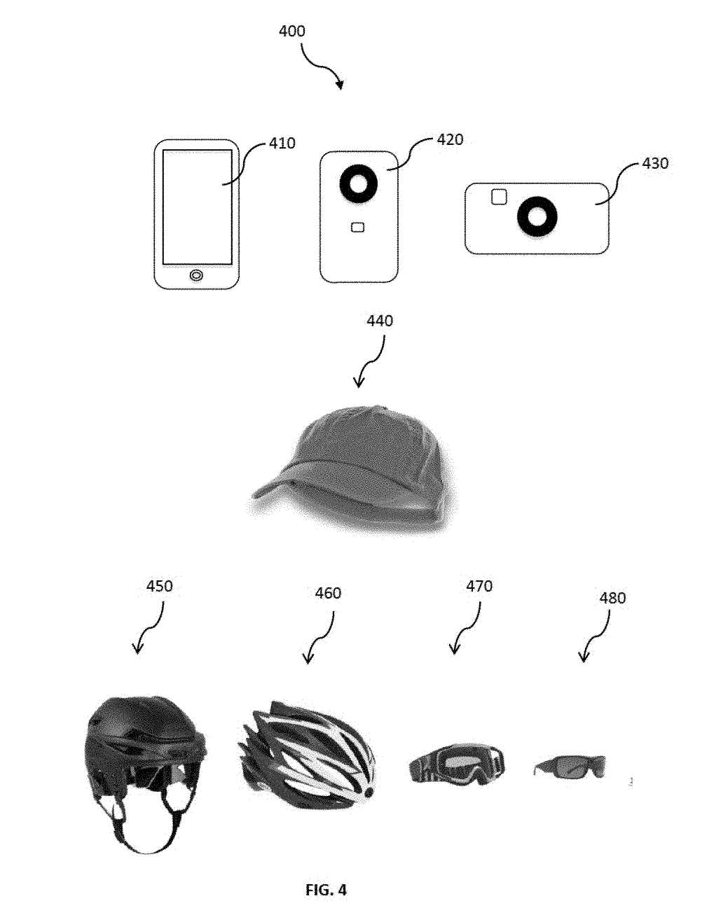

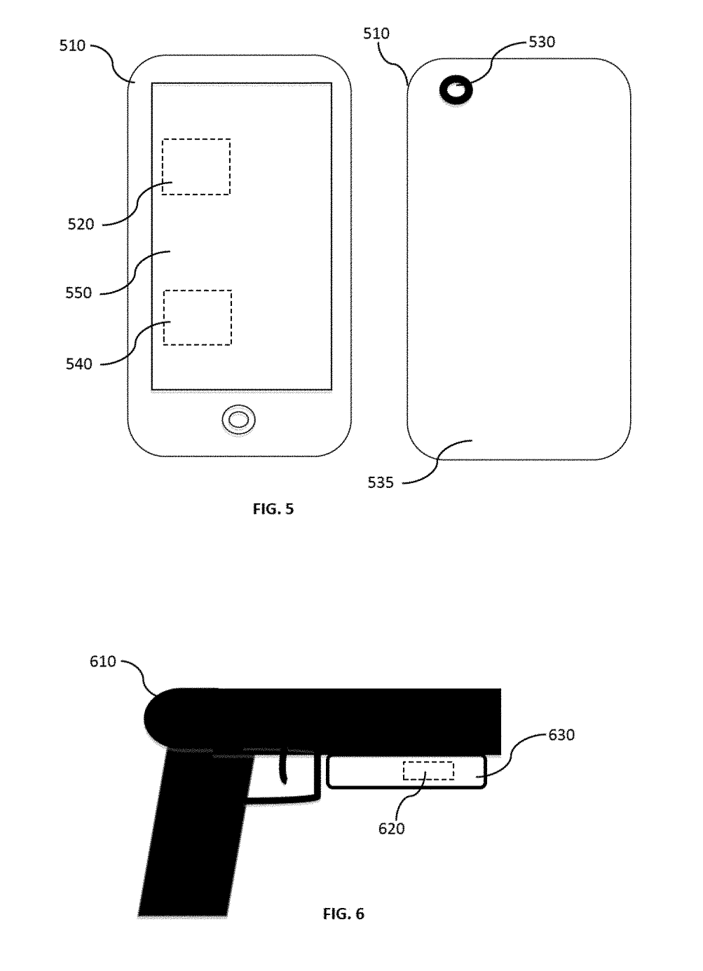

Referring to FIG. 5, front and back surfaces of a portable device provided in the form of a smartphone 510 are illustrated, in accordance with an example embodiment. The smartphone 500 configuration of a portable device depicted in FIG. 5 can include, for example, an accelerometer 520 that detects a typical upright orientation of the smartphone when a user is capturing video images using a camera 530 that is typically integrated on the rear surface 535 of the smartphone 510. Pre-record command video capturing can begin with the digital camera 530 during upright orientation of the smartphone 510, and the pre-record command video can be stored in memory 540 for a limited time and temporary basis until user activation of a record command is received on the user interface 550 (e.g., touchscreen interface) of the smartphone, where after pre-record command video is combined with post-record command video and stored in memory as a single file, in accordance with the embodiments taught herein.

Referring to FIG. 6, a portable device provided in the form of a firearm 610 is depicted, in accordance with an example embodiment. The firearm 610 configuration of a portable device can include a digital camera 630 further including an accelerometer 620 to detect a typical firing orientation of the firearm when a user is pointing a firearm at a target. When in a firing orientation, video images begin to be captured using the digital camera 630. The digital camera can be mounted to, or integrated with, the firearm 610. Pre-record command video capturing can begin with the digital camera 630 during upright “firing” orientation of the firearm 610, and the pre-record command video can be stored in a memory contained in the digital camera, or wirelessly transmitted to a connected portable computer (e.g., smartphone) where the video is stored for a limited time and temporary basis until user activation of a record command is received. The record command can be initiated when the digital camera detects that a round has been fired from the firearm, where after the digital camera begins post-recording command mode. Once in post-record command mode, both pre-record command video and post-record command video can be stored in memory or transmitted to a remote computer (e.g., smartphone or server). The pre-record command video can be combined with post-record command video and stored in memory as a single file, in accordance with the embodiments taught herein.

As can be appreciated by one skilled in the art, some example embodiments can be implemented in the context of a method, data processing system, or computer program product. Accordingly, some example embodiments may take the form of an entire hardware embodiment, an entire software embodiment, or an embodiment combining software and hardware aspects all generally referred to herein as a “circuit” or “module.” Furthermore, some example embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., Wi-Fi, Wimax, 802.xx, and cellular network or the connection may be made to an external computer via most third party supported networks (for example, through the Internet utilizing an Internet Service Provider).

The example embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

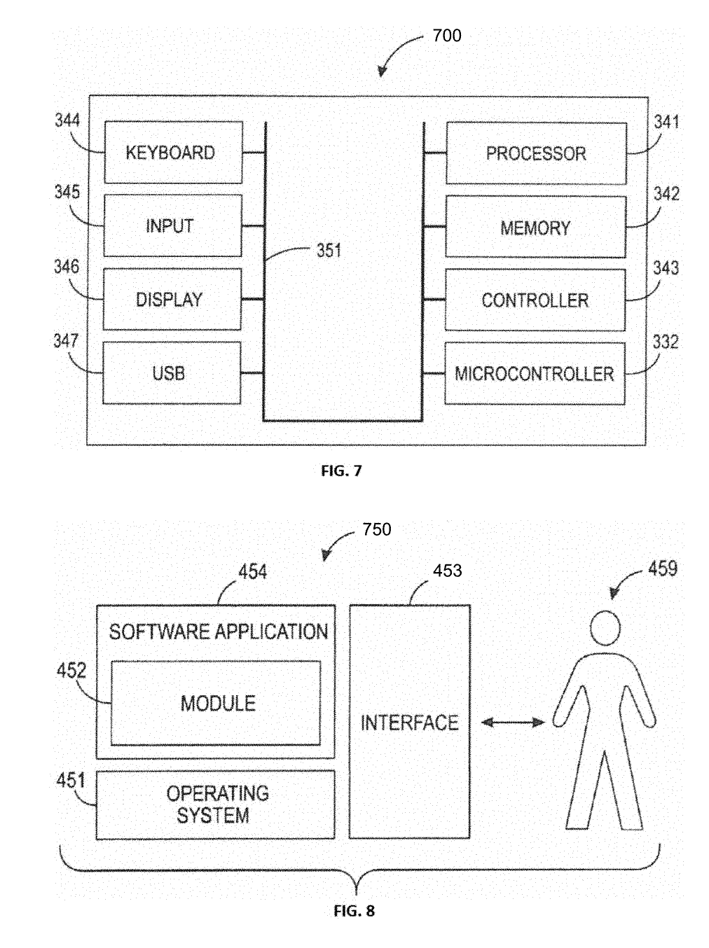

FIGS. 7-8 are shown only as exemplary diagrams of data-processing environments in which example embodiments may be implemented. It should be appreciated that FIGS. 7-8 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 7, some embodiments may be implemented in the context of a data-processing system 700 that can include, for example, one or more processors such as a processor 341 (e.g., a CPU (Central Processing Unit) and/or other microprocessors), a memory 342, an input/output controller 343, a microcontroller 332, a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.), and/or other peripheral connections and components.

As illustrated, the various components of data-processing system 700 can communicate electronically through a system bus 351 or similar architecture. The system bus 351 may be, for example, a subsystem that transfers data between, for example, computer components within data-processing system 700 or to and from other data-processing devices, components, computers, etc. The data-processing system 700 may be implemented in some embodiments as, for example, a server in a client-server based network (e.g., the Internet) or in the context of a client and a server (i.e., where aspects are practiced on the client and the server).

In some example embodiments, data-processing system 700 may be, for example, a standalone desktop computer, a laptop computer, a Smartphone, a pad computing device and so on, wherein each such device is operably connected to and/or in communication with a client-server based network or other types of networks (e.g., cellular networks, etc.).

FIG. 8 illustrates a computer software system 750 for directing the operation of the data-processing system 700 depicted in FIG. 7. Software application 454, stored for example, in memory 342, generally includes a kernel or operating system 451 and a shell or interface 453. One or more application programs, such as software application 454, may be “loaded” (i.e., transferred from, for example, mass storage or another memory location into the memory 342) for execution by the data-processing system 700. The data-processing system 700 can receive user commands and data through the interface 453; these inputs may then be acted upon by the data-processing system 700 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement instructions or operations such as those discussed herein. Module 452 may also be composed of a group of modules.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 7-8 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example as a set of operations to be performed by a computer. Such operational functional description in most instances can be specifically-configured hardware (e.g., because a general purpose computer in effect becomes a special-purpose computer once it is programmed to perform particular functions pursuant to instructions from program software). Note that the data-processing system or apparatus discussed herein may be implemented as special-purpose computer in some example embodiments. In some example embodiments, the data-processing system or apparatus can be programmed to perform the aforementioned particular instructions thereby becoming in effect a special-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a micro architecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one skilled in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendor's piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably coupleable,” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A system enabling limited and temporary queuing of video data captured by a portable device prior to user initiation of video recording commands using a portable device, comprising:
a digital camera associated with a portable device;
memory for queuing pre-record command video and for storing video after a record command is initiated by a user;
a user interface for a user to initiate the record command to cause the camera to capture and the portable device to store the video captured by the digital camera; and
software configuring the portable device to enable pre-record command video capture and queuing, post command video capture, and storage of pre-record command video combined with post-record command video upon user activation of the record command on the user interface.

2. The system of claim 1, wherein the portable device further comprises at least one of: a smartphone, tablet computer, eyeglasses, headgear, a lapel camera, and a firearm.

3. The system of claim 2, the portable device further comprising wireless access to a data communications network and social media service functionality.

4. The system of claim 1, wherein the portable device further comprises at least one of a smartphone, eyeglasses, headgear, a lapel camera with short range wireless access to a portable computer, and said portable computer provides the portable device with wireless data communications network access, access to social media applications, and social media service access and functionality.

5. The system of claim 1, wherein the portable device further comprises at least one of a smartphone, eyeglasses, headgear, a lapel camera with short range wireless access to a portable computer, and said portable computer provides the portable device with wireless data communications network access, access to a remote server, and video archiving functionality with the remote server.

6. The system of claim 1, further comprising a wireless communications module providing data communication network access, wherein the portable device can maintain wireless communications with at least one of a portable computer and a remote server.

7. The system of claim 1, wherein the portable device is a smartphone including an accelerometer, wherein the camera is integrated in a rear surface of the smartphone, and wherein said accelerometer is configured by the software to detect upright video capturing orientation of the smartphone to capture video images with the camera as pre-record command video, wherein the pre-record command video can be stored in the memory for a limited time and temporary basis until user activation of a record command is received on a user interface of the smartphone, where after pre-record command video is combined with post-record command video and stored in memory as a single file.

8. A method for limited and temporary queuing of video data captured by a portable device prior to user initiation of video recording commands using the portable device, comprising:
providing a portable device including a digital camera, a memory for storing video, and a user interface for initiating video recording commands;
continuously queuing pre-record command video captured by the digital camera on a first in, first out basis within the memory for a limited and temporary duration of time set by the user;
receiving a record command at the user interface; and
storing pre-record command video combined with post-record command video captured by the digital camera in the memory as a single file after receiving the record command at the user interface.

9. The method of claim 8, wherein the portable device further comprises at least one of: a smartphone, tablet computer, eyeglasses, headgear, a lapel camera, and a firearm.

10. The method of claim 9, wherein the portable device provides wireless access to a data communications network and social media service functionality.

11. The method of claim 8, wherein the portable device further comprises at least one of a smartphone, eyeglasses, headgear, a lapel camera with short range wireless access to a portable computer, and the portable computer provides the portable device with wireless data communications network access, access to social media applications, and social media service access and functionality.

12. The method of claim 8, wherein the portable device further comprises at least one of a smartphone, eyeglasses, headgear, a lapel camera with short range wireless access to a portable computer, and said portable computer provides the portable device with wireless data communications network access, access to a remote server, and video archiving functionality with the remote server.

13. The method of claim 8, wherein the portable device provides data network communications access and wherein the portable device can maintain wireless communications with at least one of a portable computer and a remote server.

14. The method of claim 8, wherein the portable device is a smartphone including an accelerometer and the digital camera is integrated in a rear surface of the smartphone, and wherein the accelerometer is configured by the software to detect upright video capturing orientation of the smartphone to capture video images with the digital camera as pre-record command video, the pre-record command video is stored in the memory on a first in, first out basis until the record command is received on the user interface, where after pre-record command video is combined with post-record command video and is stored in memory as a single file.

15. A smartphone enabling limited and temporary queuing of video data captured prior to user activation of a video recording command on a user interface of the smartphone, comprising:
an accelerometer;
a digital camera integrated on a rear surface of the smartphone;
a memory;
a user interface provided in the form of a touchscreen; and
software configuring the smartphone to enable pre-record command video capture upon detection of upright video capturing orientation of the smartphone using the accelerometer, temporary queuing of pre-record command video in the memory on a first in, first out basis, capturing of post-record command video upon user activation of a record command on the user interface, and storage of pre-record command video in combination with post-record command video as a single file upon user activation of the record command on a user interface.

16. The portable device of claim 15, wherein the portable device is a smartphone further comprising wireless data communications network access, access to social media applications, and social media service access and functionality.

17. The portable device of claim 15, wherein the portable device is a smartphone wherein the digital camera further comprises wireless data communications network access, access to a remote server, and video archiving functionality with the remote server.

18. The portable device of claim 16, further comprising a wireless communications module providing data communication network access, wherein the portable device can maintain wireless communications with at least one of a wearable camera adapted to capture pre-record command video and post-record command video, and access to a remote server to archive captured and recorded video files.

19. The portable device of claim 15, wherein the portable device is a firearm wherein the digital camera further comprises wireless data communications network access, access to a remote server, and video archiving functionality with the remote server.

20. The portable device of claim 19, further comprising a wireless communications module providing wireless data communication with at least one of a smartphone or remote server, wherein the digital camera is configured to capture pre-record command video and post-record command video, and transmit video to the at least one of a smartphone or remote server.
